(19) United States
(12) Patent Application Publication
(10) Pub. No.: US 2020/0209871 A1
(43) Pub. Date: Jul. 2, 2020

(54) Method and Apparatus for Analyzing Driving Risk and Sending Risk Data

(71) Applicant: Huawei Technologies Co., Ltd., Shenzhen (CN)

(72) Inventors: Fuxiang Xiong, Shenzhen (CN); Hui Li, Shenzhen (CN)

(21) Appl. No.: 16/815,814

(22) Filed: Mar. 11, 2020

Related U.S. Application Data
(63) Continuation of application No. PCT/CN2018/103740, filed on Sep. 3, 2018.

(30) Foreign Application Priority Data
Sep. 12, 2017 (CN) 201710819290.6

(51) Int. Cl. G05D 1/02; H04W 4/44; G08G 1/01

(52) U.S. Cl. CPC G05D 1/0214; G08G 1/0133; G08G 1/0116; H04W 4/44

(57) ABSTRACT

A method including obtaining a location of a first device on which risk analysis is to be performed, determining a first risk area based on a vehicle traveling line corresponding to the location, where the first risk area is an area that affects a driving behavior of a vehicle in which the first device is located, performing filtering for the first risk area, to obtain risk data, and sending the risk data to the first device.

### CROSS-REFERENCE TO RELATED APPLICATIONS

This application is a continuation of International Patent Application No. PCT/CN2018/103740, filed on Sep. 3, 2018, which claims priority to Chinese Patent Application No. 201710819290.6, filed on Sep. 12, 2017. The disclosures of the aforementioned applications are hereby incorporated by reference in their entireties.

### TECHNICAL FIELD

This application relates to the field of internet of vehicles technologies, and in particular, to a method and an apparatus for analyzing a driving risk and sending risk data.

### BACKGROUND

A vehicle to everything (V2X) technology is a new development trend of the internet of vehicles. V2X is a general term for vehicle to vehicle (V2V), vehicle to pedestrian (V2P), and vehicle to network (V2I). To ensure safe driving of vehicles, different vehicles on a road need to be able to exchange some data with each other. By processing the data, the vehicles can learn about road and vehicle conditions, for example, a vehicle accident ahead. An accident may even be predicted such that a driver is warned to change a driving policy.

With development of the V2X technology, a Long-Term Evolution (LTE)-V2X (LTE-V2X) technology is gradually introduced. In the LTE-V2X technology, a vehicle acts as a user equipment (UE) in a cellular network, where UEs may directly communicate with each other through broadcast, without forwarding by a base station, or UE may send data to a base station through unicast, and the base station forwards the data to another UE in a broadcast or multicast manner.

In a data sending process, all data is sent through broadcast, and a data amount is large. However, data transmission resources that can be provided by the base station are limited. As a result, there is still a relatively high data sending latency, and communication performance is relatively poor.

### SUMMARY

Embodiments of this application provide a method and an apparatus for analyzing a driving risk and sending risk data, to resolve a problem of a high data sending latency and poor communication performance during implementation of a V2X-related application.

According to a first aspect, a method for analyzing a driving risk and sending risk data is provided, including obtaining a location of a first device on which risk analysis is to be performed, and determining a first risk area based on a vehicle traveling line corresponding to the location, where the first risk area is an area that affects a driving behavior of a vehicle in which the first device is located, performing filtering for the first risk area, to obtain risk data, and sending the risk data to the first device, where the risk data includes status data of a vehicle, a pedestrian, and an obstacle that have a risk of colliding with the vehicle in which the first device is located, and traffic environment data that affects the driving behavior of the vehicle in which the first device is located.

The risk data may include vehicle status data, sensed data of a roadside sensor and an in-vehicle sensor, and traffic environment data. The vehicle status data is a motion status of a vehicle. The sensed data of the in-vehicle sensor is statuses, of a surrounding vehicle, pedestrian, and obstacle, sensed by the vehicle. The sensed data of the roadside sensor is statuses, of a vehicle, a pedestrian, and an obstacle, sensed by the roadside sensor. The traffic environment data is generated by a second device. The second device may be the first device, or may be a device such as a signal light, a signpost, or a central service unit (CSU).

The second device such as a signal light or a signpost has a corresponding control area. Because such a second device is disposed at a location on a road segment, an area that is affected by a status change of the second device is the control area of the second device. Therefore, in this embodiment of this application, a control area database corresponding to such a second device may be maintained for the second device, where the control area database may be a database independent of a geographic information database, or may be a same database as the geographic information database such that when a status of any second device changes, a control area corresponding to a location of the second device can be determined based on the control area database.

According to the method provided in this embodiment of this application, a risk analysis device filters, in real time, nearby risk data for the vehicle in which the first device is located. Because a data amount of risk data can be reduced through filtering, a data sending latency is greatly reduced. In addition, a bandwidth requirement for vehicle status data notification between devices can be reduced, and communication performance is improved. Moreover, the first device is enabled to flexibly sense a status of a nearby vehicle, to implement driving assistance.

In a possible design, the determining a first risk area based on a vehicle traveling line corresponding to the location includes determining, based on the location, a vehicle traveling line corresponding to the first device, where the vehicle traveling line corresponding to the first device includes at least one of a vehicle traveling line on which the first device is located, a vehicle traveling line adjacent to the first device, or a traveling line that crosses the vehicle traveling line on which the first device is located, and classifying at least one of a first subarea, a second subarea, or a third subarea as the first risk area, where the first subarea is an area that is in a first preset range ahead of and/or behind the first device and that is located on the vehicle traveling line on which the first device is located, the second subarea is an area that is in a second preset range ahead of and/or behind the first device and that is located on the vehicle traveling line adjacent to the first device, and the third subarea is an area that is in a third preset range in which a cross point is traveled to and that is located on the traveling line that crosses the vehicle traveling line on which the first device is located.

A classification policy of the first risk area may be determined based on a request of the first device or a pre-configuration of the risk analysis device.

In a possible design, the performing filtering for the first risk area, to obtain risk data includes filtering vehicle status data in a vehicle status database and/or sensed data in a database of sensor sensed data based on the first risk area, and using vehicle status data and/or sensed data of a vehicle in the first risk area as the risk data. In this possible design, a combination of the vehicle status data and the sensed data can provide more comprehensive data for a driving behavior, and has a greater reference value.

In a possible design, the risk data is current-moment risk data obtained through prediction. In this possible design, the risk data may be predicted data obtained through prediction based on a time difference between a current moment and the data and based on risk data obtained through preliminary filtering. The first device may directly use the predicted data, without performing prediction based on the time difference between the current moment and the data.

In a possible design, the performing filtering for the first risk area, to obtain risk data includes filtering traffic environment data in a traffic environment database based on the first risk area, and using traffic environment data of a vehicle in the first risk area as the risk data. In this possible design, an emergency event that occurs on a current road, a road congestion status, or a road condition indicated by a signal light or a signpost on a road may be further learned about with reference to the traffic environment data such that a better prompt effect can be achieved while transmission resources are saved.

In a possible design, the sending the risk data to the first device includes sending risk data whose emergency degree is higher than or equal to a preset high level to the first device when a first period is reached, sending risk data whose emergency degree is higher than or equal to a preset medium level to the first device when a second period is reached, and sending the risk data to the first device when a third period is reached, where a time span of the first period is less than a time span of the second period, and the time span of the second period is less than a time span of the third period. In this design, the risk data may be classified based on emergency degrees, and different sending policies are used based on the emergency degrees such that timeliness of emergent risk data can be improved, and normal sending of risk data that is relatively not emergent can be ensured.

In a possible design, sending policies corresponding to different emergency degrees are preconfigured by the risk analysis device or determined based on a request of the first device.

In a possible design, the sending the risk data to the first device includes, when the risk data includes status data of two or more devices, packetizing the risk data into a data packet, and sending the data packet to the first device, or when the risk data includes status data of two or more devices, packetizing each piece of status data into a data packet to obtain a plurality of data packets, and sending the plurality of data packets sequentially to the first device.

In a possible design, the sending the plurality of data packets sequentially to the first device includes sending the plurality of data packets to the first device in descending order of emergency degrees of the status data. In this possible design, the first device can receive a data packet based on an emergency degree, to provide a driving prompt based on a most emergent situation. This greatly improves data timeliness.

In a possible design, data is exchanged between the first device and the risk analysis device is based on a local breakout (LBO) function or a mobile edge computing (MEC) function of a network element device in a cellular network, and the network element device is a radio base station, a wireless core-network network element, or a network element between a radio base station and a wireless core-network network element. Technical solutions provided in this application may be applied to any network architecture, for example, second generation (2G), third generation (3G), fourth generation (4G), and fifth generation (5G), and specific implementation processes thereof are similar.

In a possible design, the sending the risk data to the first device includes obtaining stored address information of the first device and stored address information of a network element device to which the first device belongs and that directly interacts with the risk analysis device, and sending the risk data using the network element device to which the first device belongs.

In a possible design, the first device includes any terminal device that supports V2X.

In a possible design, the terminal device that supports V2X includes an on-board unit (OBU), a smartphone, an on-board control unit (T-Box), or an event data recorder.

According to a second aspect, a method for analyzing a driving risk and sending risk data is provided. The method is applied to a risk analysis device and includes receiving traffic environment data, and obtaining a target location, where the target location is a location at which the traffic environment data on which risk analysis is to be performed is generated, determining a second risk area based on a vehicle traveling line corresponding to the target location, where the second risk area is an area that is affected by a status change of a second device at the target location, performing filtering for a first device in the second risk area, and sending the traffic environment data to at least one first device that is obtained through filtering.

In a possible design, when no device is obtained through filtering, the traffic environment data is ignored. In an embodiment, there may be no affected vehicle in the second risk area. Therefore, when no device is obtained through filtering, the traffic environment data may not be sent.

In a possible design, the determining a second risk area based on a vehicle traveling line corresponding to the target location includes, when the second device is a first device, determining a vehicle traveling line corresponding to the first device at the target location, where the vehicle traveling line corresponding to the first device includes at least one of a vehicle traveling line on which the first device is located, a vehicle traveling line adjacent to the first device, or a traveling line that crosses the vehicle traveling line on which the first device is located, and classifying, as the second risk area, an area that is along the vehicle traveling line corresponding to the first device and that is in a fourth preset range ahead of and/or behind the first device.

In a possible design, the determining a second risk area based on a vehicle traveling line corresponding to the target location includes obtaining, based on a control area of the second device at the target location, a vehicle traveling line in the control area of the second device at the target location, and classifying, as the second risk area, an area that is along the vehicle traveling line and that is in a fifth preset range in which the target location is traveled to.

In a possible design, the second device is a traffic signal light, a signpost, or a CSU.

In a possible design, a classification policy of the second risk area varies with an event type and/or a road segment configuration indicated by the traffic environment data.

In a possible design, the performing filtering for a first device in the second risk area includes filtering vehicle status data in a vehicle status database based on the second risk area, to obtain at least one first device located in the second risk area.

In a possible design, the sending the traffic environment data to at least one first device that is obtained through filtering includes, when the at least one first device comprises two or more first devices, sending the traffic environment data separately to the two or more first devices in ascending order of distances between the at least one first device and the target location. To ensure a timeliness requirement of event notification, a distance between each first device and an event occurrence location namely, the target location, may be determined based on a location of the at least one first device, and then the traffic environment data is sent in ascending order of distances.

In a possible design, the sending the traffic environment data to at least one first device that is obtained through filtering includes, when a risk analysis period of any one of the at least one first device is reached, adding the traffic environment data to risk data, and sending the risk data to the first device.

According to a third aspect, an apparatus for analyzing a driving risk and sending risk data is provided, and is applied to a risk analysis device. The apparatus includes a plurality of functional modules, to implement the method for analyzing a driving risk and sending risk data in any one of the first aspect or the possible designs of the first aspect.

According to a fourth aspect, an apparatus for analyzing a driving risk and sending risk data is provided, and is applied to a risk analysis device. The apparatus includes a plurality of functional modules, to implement the method for analyzing a driving risk and sending risk data in any one of the second aspect or the possible designs of the second aspect.

According to a fifth aspect, a risk analysis device is provided. The risk analysis device stores a plurality of instructions, and the instructions are suitable to be loaded and executed by a processor to implement the method for analyzing a driving risk and sending risk data in any one of the first aspect or the possible designs of the first aspect.

According to a sixth aspect, a risk analysis device is provided. The risk analysis device stores a plurality of instructions, and the instructions are suitable to be loaded and executed by a processor to implement the method for analyzing a driving risk and sending risk data in any one of the second aspect or the possible designs of the second aspect.

According to a seventh aspect, a computer readable storage medium is provided. The computer readable storage medium stores an instruction, and the instruction is executed by a processor to implement the method for analyzing a driving risk and sending risk data in any one of the first aspect or the possible designs of the first aspect.

According to an eighth aspect, a computer readable storage medium is provided. The computer readable storage medium stores an instruction, and the instruction is executed by a processor to implement the method for analyzing a driving risk and sending risk data in any one of the second aspect or the possible designs of the second aspect.

### BRIEF DESCRIPTION OF DRAWINGS

FIG. 1 is a schematic diagram of an implementation environment according to an embodiment of this application.

FIG. 2 is a schematic diagram of a network architecture according to an embodiment of this application.

FIG. 3 is a schematic diagram of a network architecture according to an embodiment of this application.

FIG. 4 is a schematic diagram of a network architecture according to an embodiment of this application.

FIG. 5 is a schematic diagram of a network architecture according to an embodiment of this application.

FIG. 6 is a schematic diagram of a network architecture according to an embodiment of this application.

FIG. 7 is a structural block diagram of a risk analysis device according to an embodiment of this application.

FIG. 8 is a flowchart of a method for analyzing a driving risk and sending risk data according to an embodiment of this application.

FIG. 9 is a schematic diagram of implementation environment-based data transmission directions.

FIG. 10 is a schematic diagram of vehicle traveling lines according to an embodiment of this application.

FIG. 11 is a flowchart of a method for analyzing a driving risk and sending risk data according to an embodiment of this application.

FIG. 12 is a schematic diagram of implementation environment-based data transmission directions.

FIG. 13 is a flowchart of a method for analyzing a driving risk and sending risk data according to an embodiment of this application.

FIG. 14 is a schematic diagram of implementation environment-based data transmission directions.

FIG. 15 is a flowchart of a method for analyzing a driving risk and sending risk data according to an embodiment of this application.

FIG. 16 is a schematic diagram of implementation environment-based data transmission directions.

FIG. 17 is a flowchart of a method for analyzing a driving risk and sending risk data according to an embodiment of this application.

FIG. 18 is a schematic diagram of implementation environment-based data transmission directions.

FIG. 19 is a schematic structural diagram of an apparatus for analyzing a driving risk and sending risk data according to an embodiment of this application.

FIG. 20 is a schematic structural diagram of an apparatus for analyzing a driving risk and sending risk data according to an embodiment of this application.

### DESCRIPTION OF EMBODIMENTS

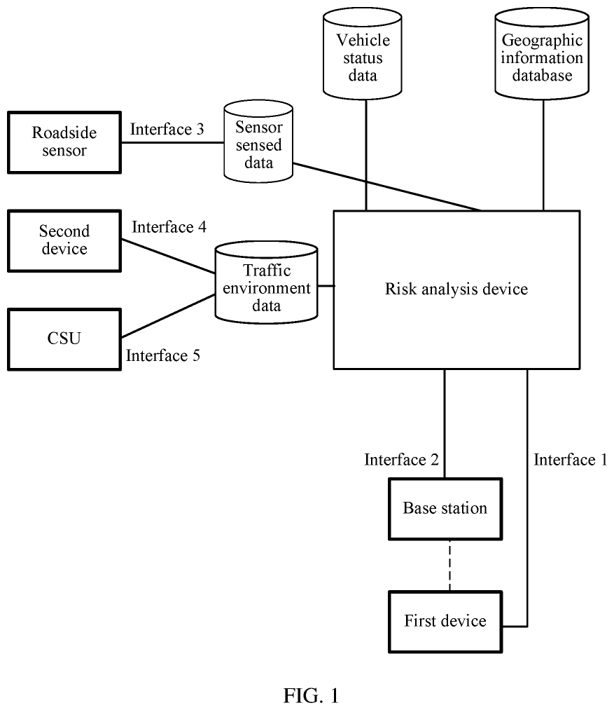

To facilitate understanding of this application, an implementation environment of the data sending method is described herein. Referring to FIG. 1, the implementation scenario includes a first device, a second device, a roadside sensor, a base station, and a risk analysis device.

The first device is any terminal device that supports V2X, such as an OBU, a smartphone, an T-Box, or an event data recorder. The OBU is used as an example. The OBU may be on board, or may be in a form of a combination of a T-Box and a smartphone. The OBU can obtain status data such as lane-level location data and a vehicle speed, and send the data periodically to a traffic control unit (TCU) through a cellular network. In addition, the OBU can receive risk data, for example, data such as alarm data, event data, signal light data, or signpost data, and provides a prompt to a driver based on the risk data using voice, video, or the like. Another possible implementation form of the first device may also have similar functions, or use a different function design based on a different design requirement of a designer, to implement some functions or more abundant functions. Specific details are not described herein.

The second device may be a device of a same type as the first device, or may be a device of a different type. For example, the second device may be a device used to prompt for a road condition or indicate a road condition change, such as a signal light/signpost. Such a device can provide data such as traffic signal light data or traffic signpost data to the TCU, and the TCU forwards the data to the first device that is in a control area of a signal light or a signpost. The second device may be alternatively a CSU. The CSU can send risk data such as alarm data or traffic environment data to the TCU, and the TCU forwards the data to the first device.

The second device such as a signal light or a signpost has a corresponding control area. Because such a second device is disposed at a location on a road segment, an area that is affected by a status change of the second device is the control area of the second device. Therefore, in the embodiments of this application, a control area database corresponding to such a second device may be maintained for the second device such that when a status of any second device changes, a control area corresponding to a location of the second device can be determined based on the control area database.

The roadside sensor may be a sensor device such as a camera, a laser radar, or a millimeter wave radar. Sensed data generated by the roadside sensor may be an originally collected video stream or point cloud data of a radar. Such a roadside sensor may be disposed on a road side based on a requirement, to obtain sensed data in a control area of the roadside sensor. The sensed data is actually status data of a vehicle, a pedestrian, and an obstacle. The status data is sent to the TCU, and the TCU can analyze a vehicle driving risk with reference to the status data.

The base station is configured to provide wireless communication between the first device or the second device and the TCU, and may be a base station in a 2G, 3G, 4G, or 5G network.

The risk analysis device may be configured in the TCU, where the TCU may be a server deployed on a network side. The TCU coordinates with a communications network, receives status data and the like from the first device and/or the second device using a LBO capability or a MEC capability of the network, analyzes the data, applies for a network resource based on a requirement, and sends the data to an OBU by applying different sending policies. The sending policies may be set in consideration of a requirement such as an emergency degree, a latency, or reliability. For data exchange between the TCU and the first device, the LBO or MEC capability of the network can be used to reduce a communication latency.

Communication between first devices, between the first device and the second device, and between the first device and the network all need to be performed using the TCU. A process of vehicle status data notification between vehicles, a process of sending alarm data between vehicles, a process of sharing sensed data between a road and a vehicle or between vehicles, or a process of sending traffic environment data by a roadside device (a signal light or a signpost) or a CSU to the first device, and another process can be implemented in such a communication manner.

In addition, in the foregoing implementation environment, LTE-Uu is an interface between the base station and the first device, and is also a physical access layer interface for communication between the OBU and the TCU. In the foregoing implementation environment, for example, in a 4G LTE network, the LTE-Uu interface may be an interface between a terminal and a 2G, 3G, 4G, or 5G cellular network. An interface 1 is an application layer interface for communication between the OBU and the TCU. The first device sends vehicle status data, event data, and sensed data to the TCU through the interface 1, and the TCU sends risk data and traffic environment data to the first device through the interface 1. An interface 2 is an interface for communication between the TCU and the communications network. The TCU needs to use the LBO capability and the MEC capability of the network to reduce a communication latency, to implement an anti-collision driving assistance application with high real-time quality. The TCU is connected to different network element devices in a cellular network based on a deployment requirement. Different network element devices provide different interfaces. The TCU needs to be adapted to these interfaces to ensure a communication latency, reliability, and bandwidth between the first device and the TCU. An interface 3 is an interface for communication between the TCU and the roadside sensor. An interface 4 is an interface between the TCU and the signal light or the signpost. An interface 5 is an interface between the TCU and the CSU.

In the entire implementation environment, the TCU may be further provided with a vehicle status database, a database of sensed data, a geographic information database, and the like that are described one by one below.

The vehicle status database is used to store vehicle status data that is periodically reported by the first device, where the vehicle status data includes data such as a location, a speed, an acceleration, a steering angle, an angular velocity, an angular acceleration, a vehicle size, and a weight of a vehicle.

The database of sensor sensed data is used to store sensed data of the roadside sensor and an in-vehicle sensor. The sensed data may be an originally collected video stream, point cloud data of a radar, or analyzed structured data such as a location, a speed, a steering angle, or a size of a pedestrian, a vehicle, or an obstacle. The original video stream data or the point cloud data of the radar first needs to be analyzed to obtain identifiable structured data such as a location, a speed, a steering angle, or a size of a pedestrian, a vehicle, or an obstacle.

The geographic information database is used to store vehicle traveling line data. The vehicle traveling line data is a geographic location trajectory diagram obtained by traveling along a centerline of a lane by a vehicle. The vehicle traveling line data may be obtained from a lane-level high-precision map or by recording a traveling trajectory of the vehicle along the centerline of the lane. It should be noted that the geographic information database may further store data in a range of a risk area of a road segment and the control area of the second device based on a form of a vehicle traveling line. The geographic information database may further store a device location of the second device, for example, an installation location of the second device.

In the foregoing content, functions of the devices in the implementation environment are mainly described. When the first device exchanges data with the risk analysis device, capabilities that can be provided by network element devices in the cellular network need to be used to reduce the communication latency in order to implement the anti-collision application with high real-time quality. Some network element devices can provide the LBO capability. Some network element devices can provide the MEC capability. Some network element devices, despite their high locations, have small actual coverage areas in deployment, and a latency of arriving at a terminal can also meet a requirement of the application with high real-time quality. All these require the TCU to be adapted to capabilities of different network element devices. For example, in a 4G LTE network, the risk analysis device is configured in the TCU. In this case, the TCU may coordinate with the network element devices in the following solutions.

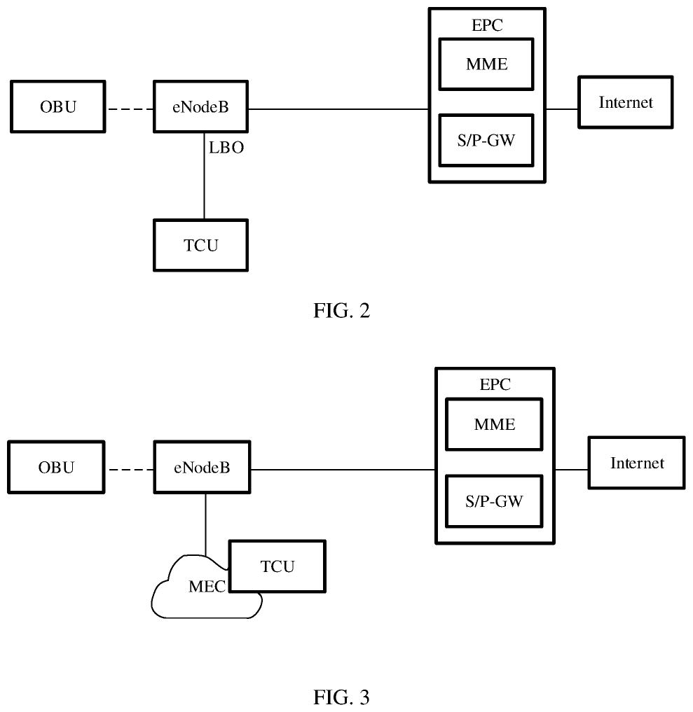

Solution 1. Based on an LBO function of an eNodeB, for a specific architecture of the TCU, refer to FIG. 2. When the OBU sends data to the TCU, the eNodeB directly sends the data to the locally configured TCU based on that a destination address of the data is the TCU. This reduces a latency caused when the data is forwarded through a core network. When the TCU sends data to the OBU, the TCU directly sends the data to the eNodeB, and the eNodeB forwards the data to the OBU. To ensure that a channel is not congested, the TCU may reserve an air interface resource based on a service requirement and a capability that is opened by the eNodeB, to ensure that emergency alarm data can be transmitted with a low latency and high reliability, and ensure sufficient bandwidth for normal-level data.

Solution 2. Based on an MEC function of an eNodeB, for a specific architecture of the TCU, refer to FIG. 3. The TCU is deployed on MEC in a form of software. A procedure is the same as that in the solution 1.

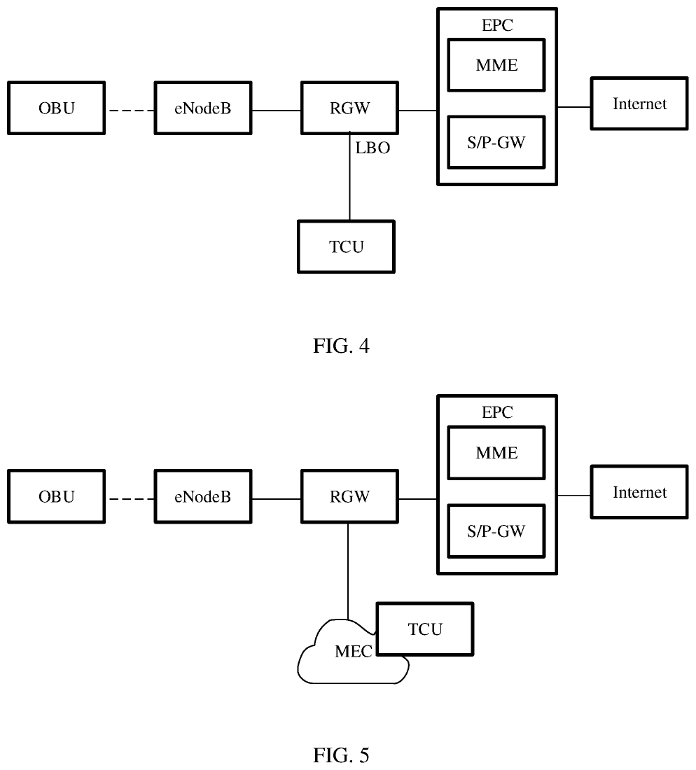

Solution 3. Based on an LBO function of a remote gateway (RGW), for a specific architecture of the TCU, refer to FIG. 4. The RGW is connected in series between an eNodeB and an evolved packet core (EPC). Data traffic may be distributed to a local device through LBO for processing, or MEC may be supported. When the OBU sends data to the TCU, the data is obtained by the RGW when being forwarded by the eNodeB to the EPC. The RGW directly sends the data to the TCU based on that a destination address of the data is the TCU. This reduces a latency caused when the data is forwarded through the core network. When the TCU sends data to the OBU, the TCU directly sends the data to the RGW, the RGW forwards the data to the eNodeB, and the eNodeB forwards the data to the OBU. To ensure that a channel is not congested, the TCU may reserve an air interface resource based on a service requirement and a capability that is opened by the RGW, to ensure that emergency alarm data can be transmitted with a low latency and high reliability, and ensure sufficient bandwidth for normal-level data.

Solution 4. Based on an MEC function of an RGW, for a specific architecture of the TCU, refer to FIG. 5. The TCU is deployed on MEC in a form of software. A procedure is the same as that in the solution 3.

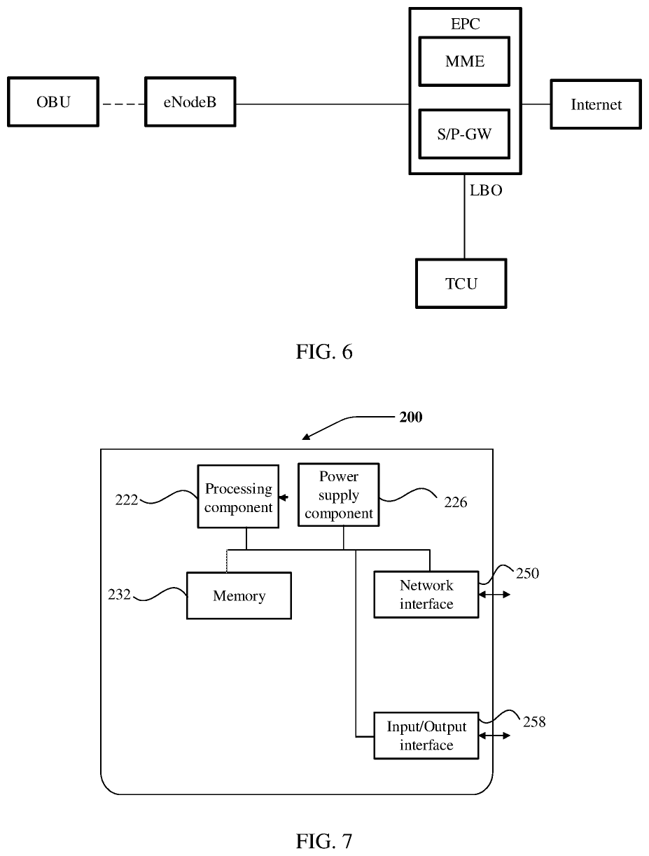

Solution 5. Based on an LBO function of an EPC, for a specific architecture of the TCU, refer to FIG. 6. When the OBU sends data to the TCU, an eNodeB forwards the data to an EPC. The EPC directly forwards the data to the TCU based on a destination address of the data. When the TCU sends data to the OBU, the TCU first sends the data to the EPC, the EPC forwards the data to the eNodeB, and the eNodeB forwards the data to the OBU. To ensure that a channel is not congested, the TCU may reserve an air interface resource based on a service requirement and a capability that is opened by the EPC, to ensure that emergency alarm data can be transmitted with a low latency and high reliability, and ensure sufficient bandwidth for normal-level data.

It should be noted that during deployment of an implementation environment, devices of different types may be deployed for a road based on an actual requirement, and different databases may be further correspondingly deployed for data collection and data storage. In an embodiment, in the implementation environment architectures shown in FIG. 1 to FIG. 6, a device may be added or reduced based on an actual requirement, or an association and a communications interface between devices may be changed, or the like. This is not specifically limited in the embodiments of this application.

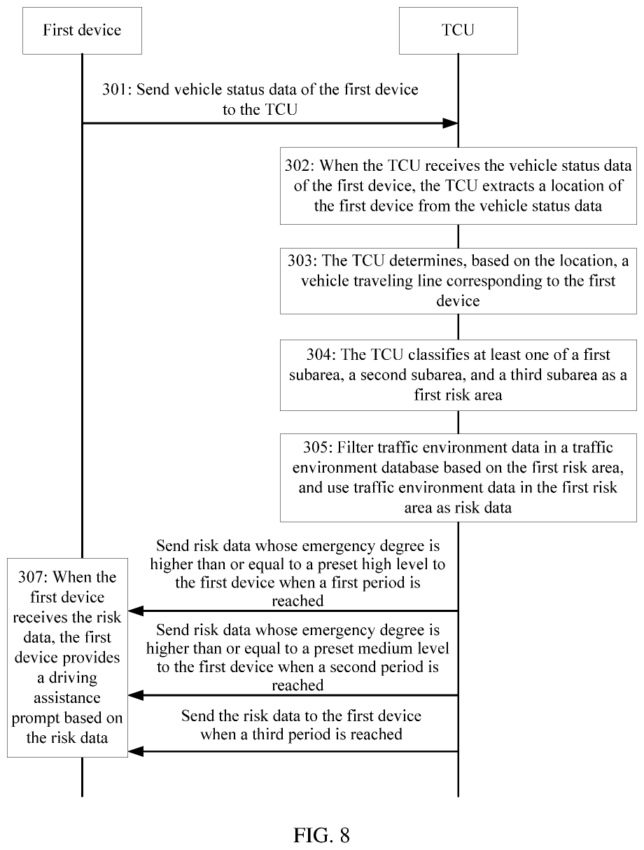

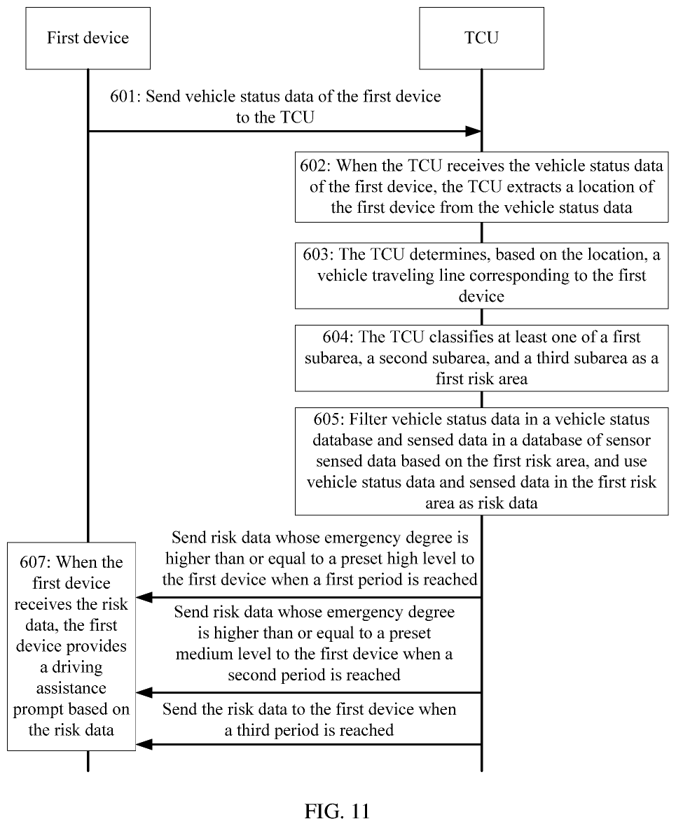

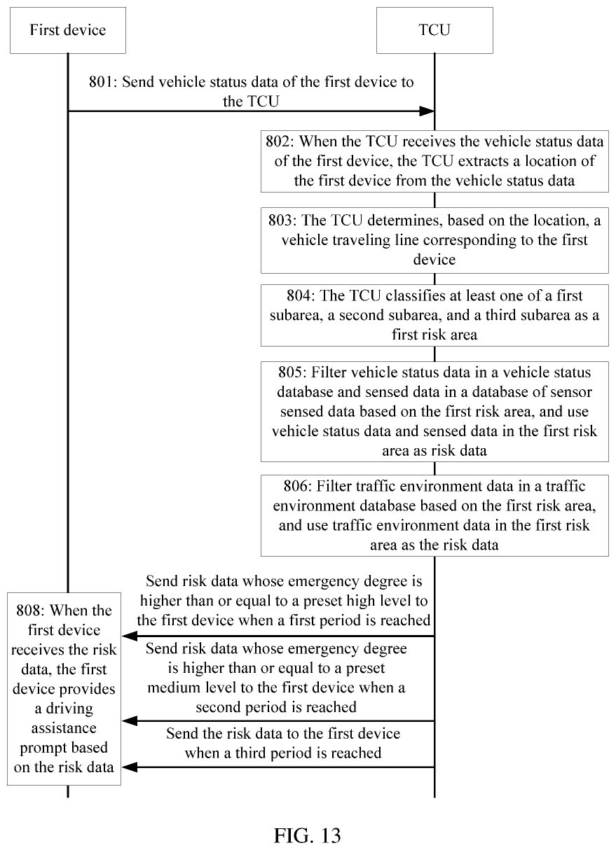

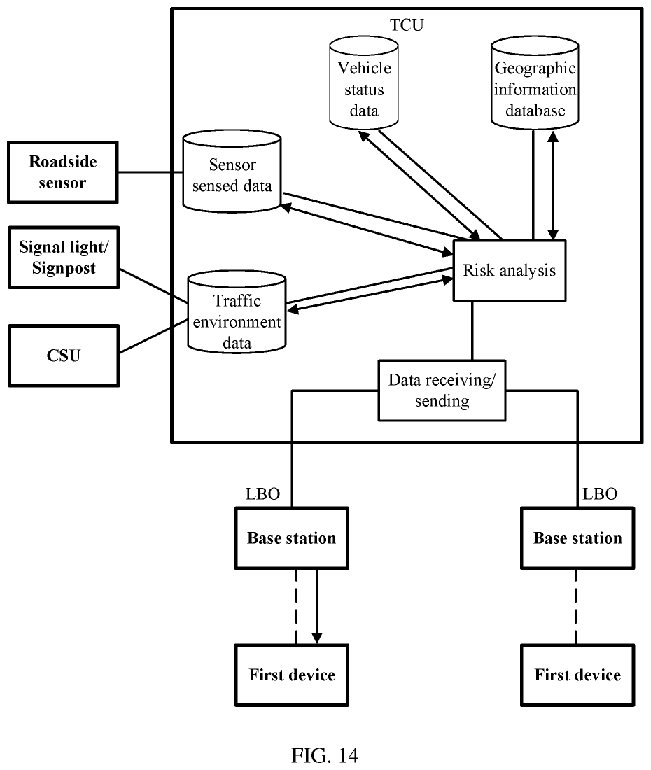

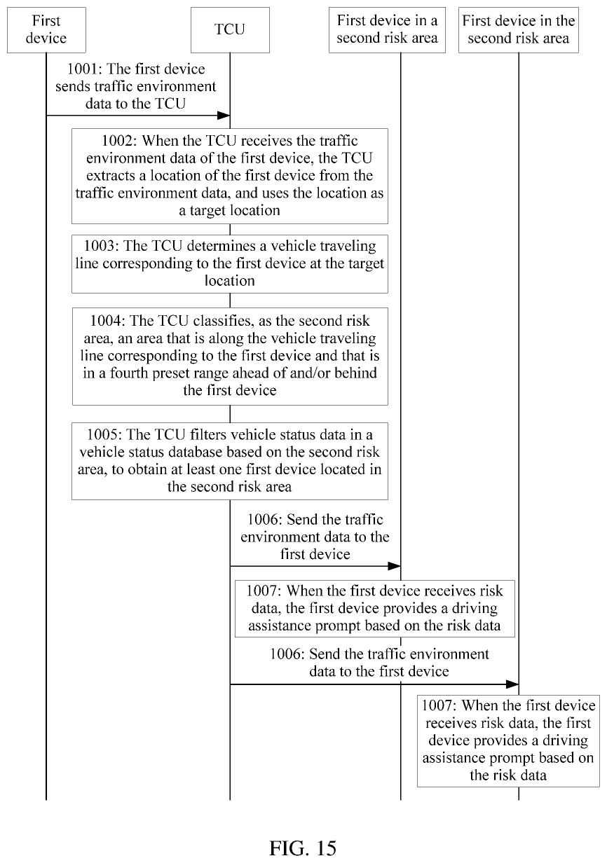

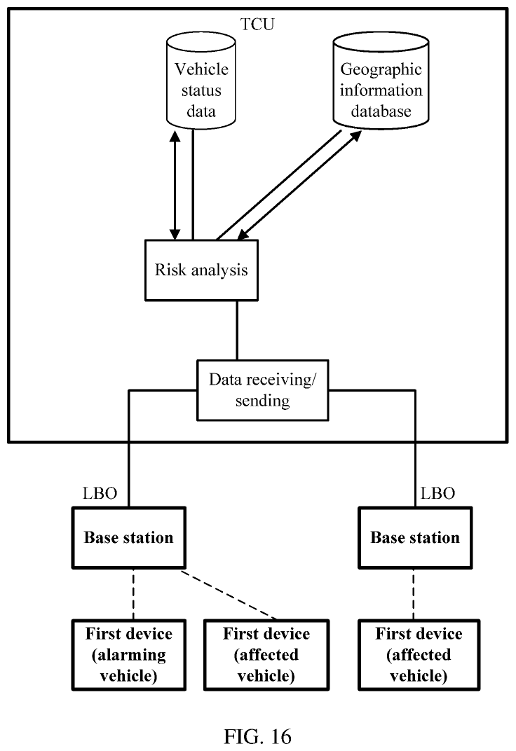

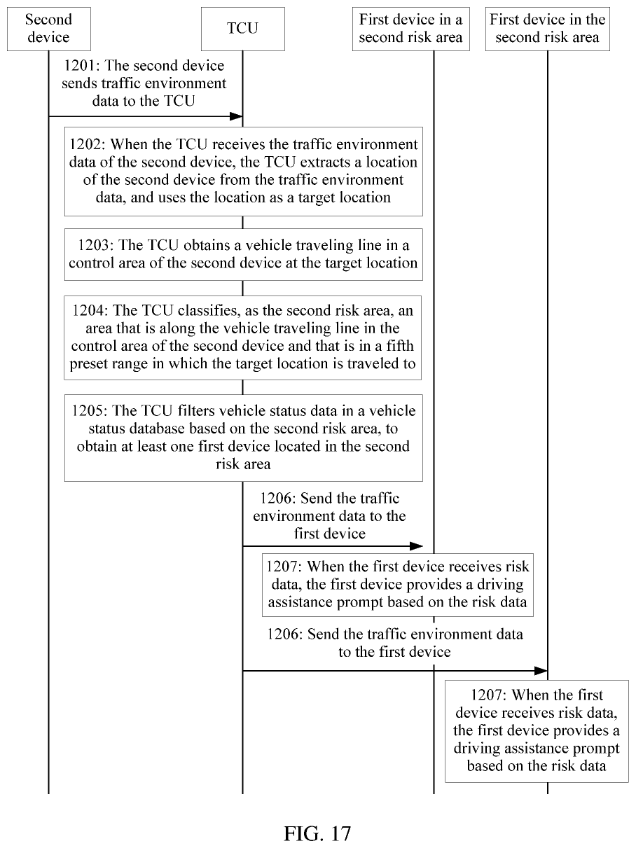

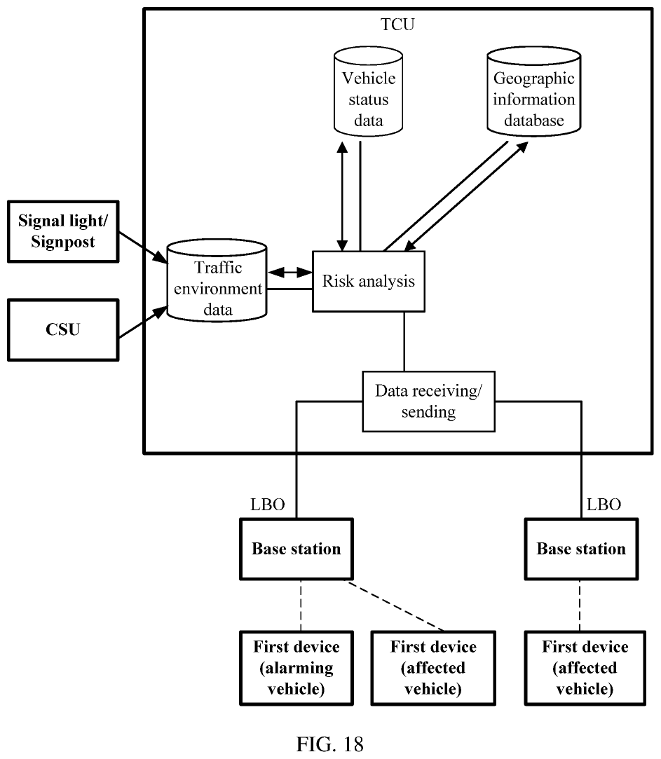

FIG. 7 is a structural block diagram of a risk analysis device according to an embodiment of this application. For example, the risk analysis device 200 may be provided as a server. Referring to FIG. 7, the risk analysis device 200 includes a processing component 222 that further includes one or more processors, and memory resources represented by a memory 232 configured to store an instruction, for example, an application program, that can be executed by the processing component 222. The application program stored in the memory 232 may include one or more modules, where each of the modules corresponds to a set of instructions. In addition, the processing component 222 is configured to execute an instruction to perform a risk analysis device-side method for analyzing a driving risk and sending risk data in any one of the following embodiments shown in FIG. 8, FIG. 11, FIG. 13, FIG. 15, or FIG. 17.

The risk analysis device 200 may further include a power supply component 226 configured to perform power management of the risk analysis device 200, a wired or wireless network interface 250 configured to connect the risk analysis device 200 to a network, and an input/output (I/O) interface 258. The risk analysis device 200 may operate based on an operating system stored in the memory 232, for example, Windows Server™, Mac OS X™ Unix™, Linux™, FreeBSD™, or the like.

In an example embodiment, a computer readable storage medium is further provided, for example, a memory including an instruction. The instruction may be executed by the processor in the risk analysis device, to implement a method for analyzing a driving risk and sending risk data in the following embodiments. For example, the computer readable storage medium may be a read only memory (ROM), a random access memory (RAM), a compact disc ROM (CD-ROM), a magnetic tape, a floppy disk, or an optical data storage device.

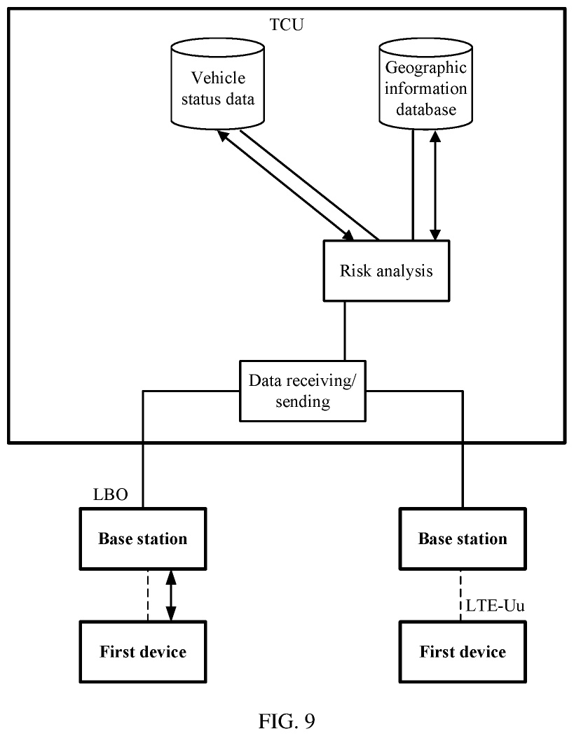

FIG. 8 is a flowchart of a method for analyzing a driving risk and sending risk data according to an embodiment of this application. FIG. 9 is a schematic diagram of implementation environment-based data transmission directions. Referring to FIG. 8 and FIG. 9, descriptions are provided using an example in which a risk analysis device is a TCU. The method includes the following steps.

301. A first device sends vehicle status data of the first device to the TCU.

For the first device, the first device may send the vehicle status data of the first device to the TCU periodically (for example, at a frequency of 10 hertz (Hz)), to notify the TCU of a traveling status of the first device. The vehicle status data includes a location, a speed, an acceleration, a steering angle, an angular velocity, an angular acceleration, a vehicle size, weight data, and the like of a vehicle.

302. When the TCU receives the vehicle status data of the first device, the TCU extracts a location of the first device from the vehicle status data.

When the TCU receives the vehicle status data of the first device, the TCU may trigger a risk analysis procedure for the first device, to analyze, for the first device, a risk status near the traveling location of the first device. Because the vehicle status data includes the location of the first device, the TCU can determine, by extracting the location from the vehicle status data, the location of the first device on which risk analysis is to be performed. In addition, when the TCU receives the vehicle status data, the TCU stores the vehicle status data in a vehicle status database.

The first device is disposed in the vehicle. Therefore, the location of the first device is the location of the vehicle in which the first device is located. Certainly, in this procedure, only reception of the vehicle status data of the first device by the TCU is used as a condition for triggering the risk analysis procedure. In another possible implementation, the risk analysis procedure may be alternatively triggered periodically. When a risk analysis period of the first device is reached, the location of the first device is extracted from the vehicle status database, where the vehicle status database is used to store status data of all first devices in a control area of the risk analysis device. For example, a risk analysis period may be set for each first device such that whenever a risk analysis period of a first device is reached, the TCU can start the risk analysis procedure for the first device, to analyze a risk existing near the first device.

303. The TCU determines, based on the location, a vehicle traveling line corresponding to the first device, where the vehicle traveling line corresponding to the first device includes at least one of a vehicle traveling line on which the first device is located, a vehicle traveling line adjacent to the first device, and a cross traveling line of the first device.

Based on the location of the first device, the TCU may search a geographic information database for a vehicle traveling line corresponding to the location, namely, the vehicle traveling line corresponding to the first device.

304. The TCU classifies at least one of a first subarea, a second subarea, and a third subarea as a first risk area, where the first risk area is an area that affects a driving behavior of the vehicle in which the first device is located.

Based on the vehicle traveling line corresponding to the first device, an area that is near the first device and that may affect the driving behavior of the vehicle in which the first device is located may be classified as the first risk area. The area that affects the driving behavior is usually around the first device. Therefore, during classification of the first risk area, a specific range that is ahead of and/or behind the first device along the vehicle traveling line on which the first device is located, and a specific range that is ahead of and/or behind the first device along the adjacent traveling line may be considered. If a target location is close to an intersection, there may be a vehicle coming on the cross traveling line. Therefore, a specific range along the cross traveling line at the intersection may be considered. Based on this consideration, specific classification may be performed based on the three subareas.

(1) The first subarea is an area that is in a first preset range ahead of and/or behind the first device and that is located on the vehicle traveling line on which the first device is located. It should be noted that during classification of the first risk area, the first risk area may be classified based on a preset vehicle speed and by considering warning duration for a collision ahead and/or warning duration for a collision behind on the vehicle traveling line of the first device. The classified first subarea may be only in the first preset range ahead of the first device, may be only in the first preset range behind the first device, or may be in the first preset ranges ahead of and behind the first device. The warning duration for a collision ahead may be different from the warning duration for a collision behind. For example, it is assumed that the preset vehicle speed is 120 km/h, the warning duration for a collision ahead may be set to 5 seconds, and the warning duration for a collision behind may be set to 3 seconds. In this case, the first preset range is within 166 meters ahead of the first device and within 100 meters behind the first device. Certainly, in the foregoing example, the first preset range is determined based on warning duration for a collision and the preset vehicle speed. In an embodiment, the first preset range may be determined directly based on a preset distance ahead and/or a preset distance behind, without real-time computation. The preset vehicle speed may be, for example, an average vehicle speed or a limited speed for a current road segment of the road. Different road segments may correspond to different limited speeds. Therefore, for different road segments, determined subareas may be different. This is not specifically limited in this embodiment of this application.

(2) The second subarea is an area that is in a second preset range ahead of and/or behind the first device and that is located on the vehicle traveling line adjacent to the first device. It should be noted that during classification of the first risk area, a size of a blind spot area during lane change assistance may be considered on the vehicle traveling line adjacent to the first device. The classified second subarea may be only in the second preset range that is ahead of the first device and that is on the vehicle traveling line adjacent to the first device, may be only in the second preset range that is behind the first device and that is on the vehicle traveling line adjacent to the first device, or may be in the second preset ranges that are ahead of and behind the first device and that are on the vehicle traveling line adjacent to the first device. For example, an area within 100 meters ahead of the first device and within 200 meters behind the first device on the vehicle traveling line adjacent to the first device may be used as the first risk area.

(3) The third subarea is an area that is in a third preset range in which a cross point is traveled to and that is located on the traveling line that crosses the vehicle traveling line on which the first device is located. It should be noted that during classification of the first risk area, a status of collision warning at an intersection may be considered. The third preset range may be determined based on a preset vehicle speed and warning duration for a collision. For example, a range in which the vehicle can travel to the cross point in 5 seconds may be used as the first risk area. Certainly, the third preset range may be alternatively determined based on a preset distance, for example, may be a range in which a distance from the left to the right is within 200 meters with the cross point on the cross traveling line as a center point.

It should be noted that the classified first risk area may include at least one subarea. In other words, the first risk area may include any one of the foregoing subareas, or may include at least two subareas. Certainly, in a scenario in which there is no cross traveling line near the target location, the first risk area may include the first subarea or the second subarea. In a scenario in which the target location corresponds to a single vehicle traveling line at the target location, the first risk area may include the first subarea, and may further include the third subarea. In this embodiment of this application, the first risk area may be determined based on an actual road situation. No further limitation is imposed herein. In addition, information used for determining the first risk area, such as the warning duration for a collision, may be configured based on a road segment. Corresponding data is stored in the geographic information database such that the data can be used through querying during area classification. During classification of the first risk area, geographic information of the first risk area is also extracted from the geographic information database, to be used as a basis for further filtering the vehicle status data.

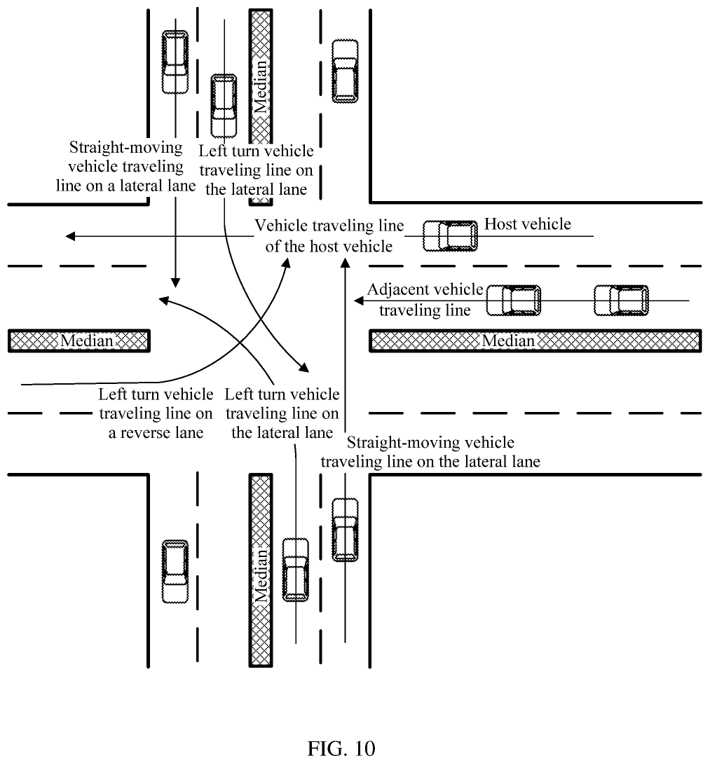

For example, FIG. 10 is a schematic diagram of vehicle traveling lines. A host vehicle represents the vehicle in which the first device on which risk analysis is to be performed is located. The host vehicle is located at a cross point. Based on a location of the host vehicle, an area that is in a first preset range ahead of and behind the host vehicle and that is on a vehicle traveling line of the host vehicle, an area in a second preset range that is ahead of and behind the host vehicle and that is on a vehicle traveling line adjacent to the host vehicle, and an area that is in a third preset range and that is on a cross traveling line of the host vehicle are classified as first risk areas.

305. Filter the vehicle status data in the vehicle status database based on the first risk area, and use vehicle status data in the first risk area as risk data.

A vehicle in the determined first risk area is a vehicle that may affect the driving behavior of the vehicle in which the first device is located. Therefore, vehicle status data of such vehicles may be obtained through filtering based on the geographic information of the first risk area. In this way, a resource waste caused by data sending through broadcast or multicast can be avoided. In addition, an amount of sent data is greatly reduced, thereby avoiding a data latency. The filtering process may be performing filtering based on the geographic information that is of the first risk area and that is obtained through filtering, to obtain the vehicle status data in the first risk area from the vehicle status database.

The filtering process provided in step 305 is actually a specific implementation of obtaining the risk data by performing data analysis on the first risk area. A timestamp in the risk data may be an original timestamp in the risk data. In another possible implementation, the database stores vehicle status data that is most recently sent by a plurality of devices. Therefore, prediction may be performed based on the data obtained through filtering and based on a current timestamp and a timestamp in the vehicle status data, to obtain predicted data at a current moment. The process may specifically include filtering the vehicle status data in the vehicle status database based on the first risk area, to obtain the vehicle status data in the first risk area, and performing prediction based on the vehicle status data in the first risk area, to obtain the risk data. In this case, the timestamp in the risk data may be the timestamp of the current moment. The first device may directly use the predicted data, without performing prediction based on a time difference between the current moment and the data.

306. Send risk data whose emergency degree is higher than or equal to a preset high level to the first device when a first period is reached, send risk data whose emergency degree is higher than or equal to a preset medium level to the first device when a second period is reached, and send the risk data to the first device when a third period is reached, where a time span of the first period is less than a time span of the second period, and the time span of the second period is less than a time span of the third period.

An emergency degree may be measured based on emergency of a potential collision. The emergency degree may be classified based on duration that is before a potential collision. Different duration intervals may be obtained through division, and each duration interval corresponds to an emergency degree level. Shorter duration before a potential collision indicates a higher emergency degree. Certainly, the emergency degree may be alternatively classified based on a distance to a potential collision. Different distance intervals may be obtained through division, and each distance interval corresponds to an emergency degree level. A shorter distance to a potential collision indicates a higher emergency degree. Certainly, the emergency degree may be alternatively determined based on a combination of duration before a collision and a distance to the collision or based on another factor. This is not limited in this embodiment of this application.

Steps 306 and 307 are a process of sending the risk data to the first device. For the first device, risk data that is urgently required by the first device should be status data of a device with a relatively large collision possibility. Therefore, to avoid excessive occupation of transmission resources, sending periods for different emergency degrees may be set based on emergency degrees of risk data. In an embodiment, the risk data whose emergency degree is higher than or equal to the preset high level is sent only at an interval of the first period, and the risk data whose emergency degree is higher than or equal to the preset medium level is sent only at an interval of the second period. For example, the first period may be 100 milliseconds (ms), and the second period may be 200 ms. In addition, to ensure integrity of the notified risk data, all data in the risk data may be sent to the first device when the third period is reached. The preset high level and the preset medium level may be preconfigured by the risk analysis device or determined based on a request of the first device.

In this embodiment of this application, sending policies corresponding to different emergency degrees are preconfigured by the risk analysis device or determined based on a request of the first device. For example, for a first device that expects to save bandwidth, risk data required by the first device includes only vehicle information of a most emergent potential collision, for a first device that has a relatively strong sense of risk, risk data required by the first device is information about all vehicles located in a risk area. Certainly, sending policies may be alternatively determined through overall balancing between communication bandwidth occupation, and real-time quality and integrity of information. For example, a data amount of vehicle information of a most emergent potential collision is smallest, and there is no such data in most cases. Therefore, such data may be sent instantly. Vehicle information of a second-most emergent potential collision may be sent based on a period of 200 ms. An amount of complete risk data is large, and such risk data may be sent based on a period of 1 s.

Correspondingly, another implementation may be alternatively used in steps 306 and 307. For example, in a possible implementation, to further reduce an amount of sent data and improve real-time quality of the risk data, risk data that is obtained through filtering and that has a relatively high emergency degree may be sent to the first device immediately when the vehicle status data of the first device is received, rather than sending all the risk data at one time. To ensure data integrity, all data in the risk data may be sent only when a second period is reached. In another possible implementation, when a risk analysis period of the first device is reached, the risk data may be sent to the first device without distinguishing between emergency degrees. In still another possible implementation, to reduce a data amount, only risk data whose emergency degree is higher than or equal to a preset high level may be sent to the first device. Certainly, alternatively, risk data with a highest emergency degree may be sent to the first device, and remaining data may be sent when a second period is reached. A specific implementation used is not specifically limited in this embodiment of this application. An implementation may be correspondingly adjusted based on a different system requirement.

Step 306 mainly describes, from a perspective of emergency degrees, which data is sent first and which data is sent later. However, during specific sending of the risk data, any one of the following sending manners may be alternatively used. In a first sending manner, when the risk data includes status data of two or more devices, the risk data is packetized into a data packet, and the data packet is sent to the first device. In a second sending manner, when the risk data includes status data of two or more devices, each piece of status data is packetized into a data packet to obtain a plurality of data packets, and the plurality of data packets are sent sequentially to the first device. This is a manner that is compatible with direct communication between vehicles and between a vehicle and a road. From a perspective of the first device, directly receiving status data of another vehicle by the first device is the same as receiving the status data that is of the other vehicle and that is forwarded by the TCU, but a data amount is greatly reduced. Further, when the plurality of data packets are sent sequentially to the first device, the plurality of data packets may also be sent to the first device in descending order of emergency degrees.

307. When the first device receives the risk data, the first device provides a driving assistance prompt based on the risk data.

The first device may implement driving assistance based on the risk data, for example, provide a collision warning. That the collision warning is specifically a warning for a collision ahead is used as an example. The first device obtains information about a vehicle ahead of the first device from the risk data through filtering, computes duration that is before a potential collision between the vehicle and the first device, and if the duration is less than a collision warning duration configured by the first device, warns a driver of a collision ahead. Certainly, the driving assistance prompt may further include other warnings, for example, a warning for a direction behind, a warning for a sideways direction, and a road condition prompt. This is not specifically limited in this embodiment of this application.

It should be noted that data may be exchanged between the first device and the TCU based on a base station (such as an eNodeB) in a cellular network. In other words, step 301 is actually a process in which the first device sends the vehicle status data to the TCU through an interface between the first device and the base station. After receiving the vehicle status data, the base station forwards the vehicle status data to the TCU based on a destination address of the vehicle status data using an LBO capability of the base station. Correspondingly, the data sending process in step 306 may also be a process in which the TCU obtains a cached location of the first device and a cached address of the base station to which the first device belongs, and forwards the risk data to the first device using the LBO capability of the base station. Certainly, the data exchange process is described using only an example in which the process is performed through LBO of the base station. In an embodiment, the data exchange process may be alternatively implemented using an LBO capability or an MEC capability of another network element device. The network element device is a base station, an RGW, or an EPC. The foregoing manner of performing communication using the LBO capability or the MEC capability can greatly reduce a communication latency.

According to the method provided in this embodiment of this application, the risk analysis device filters, in real time, nearby risk data for the vehicle in which the first device is located. Because a data amount of risk data can be reduced through filtering, a data sending latency is greatly reduced. In addition, a bandwidth requirement for vehicle status data notification between devices can be reduced, a frequency requirement for scheduling air interface resources is reduced, and communication performance is improved. Moreover, the first device is enabled to flexibly sense a status of a nearby vehicle, to implement driving assistance. Further, the risk data is classified based on emergency degrees, and different sending policies are used based on the emergency degrees. This can improve timeliness of emergent risk data, and can ensure normal sending of risk data that is relatively not emergent.

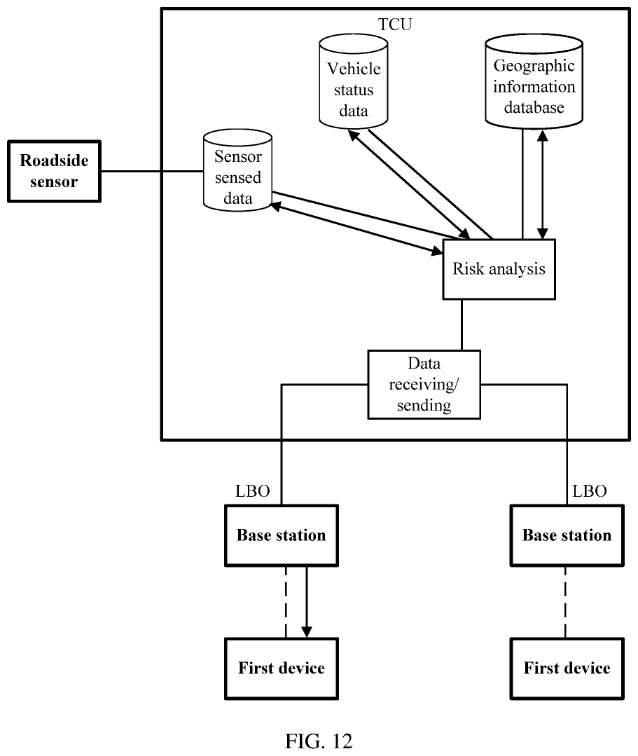

The foregoing embodiment is described using only an example in which vehicle status data is filtered. In actuality, a roadside sensor may be further deployed on a road, and an in-vehicle sensor may be further configured for a vehicle. Therefore, in an embodiment, filtering may be performed based on a combination of vehicle status data and sensed data in a database of sensor sensed data, to learn about statuses of a vehicle, a pedestrian, and an obstacle more accurately in order to better implement driving assistance. The following describes such a data sending process performed based on vehicle status data and sensed data, with reference to FIG. 11 and FIG. 12.

601. A first device sends vehicle status data of the first device to a TCU.

602. When the TCU receives the vehicle status data of the first device, the TCU extracts a location of the first device from the vehicle status data.

603. The TCU determines, based on the location, a vehicle traveling line corresponding to the first device.

604. The TCU classifies at least one of a first subarea, a second subarea, and a third subarea as the first risk area, where the first risk area is an area that affects a driving behavior of a vehicle in which the first device is located.

Steps 601 to 604 are similar to steps 301 to 304. Details are not described herein again.

605. Filter vehicle status data in a vehicle status database and sensed data in a database of sensor sensed data based on the first risk area, and use vehicle status data and sensed data in the first risk area as risk data.

Sensed data is a type of risk data, and is used to indicate statuses of a vehicle, a pedestrian, and an obstacle in a sensing area of a sensor. Therefore, based on a combination of the vehicle status data and the sensed data, accuracy and comprehensiveness of the risk data can be further improved. The filtering process may be performing filtering based on geographic information that is of the first risk area and that is obtained through filtering, to obtain the vehicle status data in the first risk area from the vehicle status database, and obtain the sensed data in the first risk area from the database of sensor sensed data. Certainly, the foregoing process may be performed in any filtering sequence. Filtering may be performed in the described sequence, or may be performed in a reverse sequence. Alternatively, filtering may be performed for the vehicle status data and the sensed data simultaneously, to improve data filtering efficiency.

Certainly, because the sensed data is also obtained periodically, prediction may also be performed based on the sensed data, to obtain predicted data. Correspondingly, such a data analysis process includes filtering the vehicle status data in the vehicle status database and the sensed data in the database of sensor sensed data based on the first risk area, to obtain the vehicle status data and sensed data in the first risk area, and performing prediction based on the vehicle status data and sensed data in the first risk area, to obtain the risk data.

606. Send risk data whose emergency degree is higher than or equal to a preset high level to the first device when a first period is reached, send risk data whose emergency degree is higher than or equal to a preset medium level to the first device when a second period is reached, and send the risk data to the first device when a third period is reached, where a time span of the first period is less than a time span of the second period, and the time span of the second period is less than a time span of the third period.

607. When the first device receives the risk data, the first device provides a driving assistance prompt based on the risk data.

Steps 606 and 607 are similar to steps 306 and 307. Details are not described herein again.

It should be noted that data analysis may be alternatively performed based on the database of sensor sensed data only. That is, the risk data includes only sensed status data of a vehicle, a pedestrian, and an obstacle. In this case, a data amount can also be reduced, and a status of a nearby vehicle can also be sensed.

According to the method provided in this embodiment of this application, a risk analysis device filters, in real time, nearby risk data for the vehicle in which the first device is located. Because a data amount of risk data can be reduced through filtering, a data sending latency is greatly reduced. In addition, a bandwidth requirement for vehicle status data notification between devices can be reduced, a frequency requirement for scheduling air interface resources is reduced, and communication performance is improved. Moreover, the first device is enabled to flexibly sense statuses of a nearby vehicle, pedestrian, and obstacle, to implement driving assistance. Further, the risk data is classified based on emergency degrees, and different sending policies are used based on the emergency degrees. This can improve timeliness of emergent risk data, and can ensure normal sending of risk data that is relatively not emergent. Still further, because the sensed data obtained by a roadside sensor is considered, accuracy and comprehensiveness of the risk data can be improved, thereby greatly improving accuracy of a driving assistance prompt, and significantly contributing to road safety.

The foregoing embodiment is described using only an example in which vehicle status data and sensed data are filtered. In actuality, an event such as a vehicle alarm event or a signal light change may occur on a road. Therefore, in an embodiment, filtering may be performed based on a combination of vehicle status data, sensed data, and traffic environment data, to learn about statuses of a vehicle, a pedestrian, and an obstacle, and a traffic condition more accurately in order to better implement driving assistance. The following describes such a process of analyzing a driving risk and sending risk data, with reference to FIG. 13 and FIG. 14.

801. A first device sends vehicle status data of the first device to a TCU.

802. When the TCU receives the vehicle status data of the first device, the TCU extracts a location of the first device from the vehicle status data.

803. The TCU determines, based on the location, a vehicle traveling line corresponding to the first device.

804. The TCU classifies at least one of a first subarea, a second subarea, and a third subarea as the first risk area, where the first risk area is an area that affects a driving behavior of a vehicle in which the first device is located.

Steps 801 to 804 are similar to steps 301 to 304. Details are not described herein again.

805. Filter vehicle status data in a vehicle status database and sensed data in a database of sensor sensed data based on the first risk area, and use vehicle status data and sensed data in the first risk area as risk data.

806. Filter traffic environment data in a traffic environment database based on the first risk area, and use traffic environment data in the first risk area as the risk data.

Traffic environment data is a type of risk data, and is used to indicate a vehicle traveling status change, a signal light or a signpost, a road condition change, and the like related to a traffic environment change. Therefore, based on a combination of the vehicle status data, the sensed data, and the traffic environment data, accuracy and comprehensiveness of the risk data can be further improved. The filtering process may be performing filtering based on geographic information that is of the first risk area and that is obtained through filtering, to obtain the vehicle status data in the first risk area from the vehicle status database, obtain the sensed data in the first risk area from the database of sensor sensed data, and obtain the traffic environment data in the first risk area from the traffic environment database. Certainly, the foregoing process may be performed in any filtering sequence. Filtering may be performed in the described sequence, or may be performed out of sequence. Alternatively, filtering may be performed for the vehicle status data, the sensed data, and the traffic environment data simultaneously, to improve data filtering efficiency.

807. Send risk data whose emergency degree is higher than or equal to a preset high level to the first device when a first period is reached, send risk data whose emergency degree is higher than or equal to a preset medium level to the first device when a second period is reached, and send the risk data to the first device when a third period is reached, where a time span of the first period is less than a time span of the second period, and the time span of the second period is less than a time span of the third period.

808. When the first device receives the risk data, the first device provides a driving assistance prompt based on the risk data.

Steps 807 and 808 are similar to steps 306 and 307. Details are not described herein again.

It should be noted that data analysis may be alternatively performed based on the vehicle status database and the traffic environment database instead of the database of sensor sensed data. In this case, a data amount can also be reduced, and a status of a nearby vehicle can also be sensed.

According to the method provided in this embodiment of this application, a risk analysis device filters, in real time, nearby risk data for the vehicle in which the first device is located. Because a data amount of risk data can be reduced through filtering, not only a bandwidth requirement for vehicle status data notification between devices can be reduced, but also the first device is enabled to flexibly sense statuses of a nearby vehicle, pedestrian, and obstacle, to implement driving assistance. Further, the risk data is classified based on emergency degrees, and different sending policies are used based on the emergency degrees. This can improve timeliness of emergent risk data, and can ensure normal sending of risk data that is relatively not emergent. Still further, because the traffic environment data is considered, accuracy and comprehensiveness of the risk data can be improved, thereby greatly improving accuracy of a driving assistance prompt, and significantly contributing to road safety.

The foregoing embodiments are described using only an example in which risk analysis is performed on a device. In actuality, data sending further includes sending of traffic environment data. The traffic environment data may be used for notification of some events that affect a driving behavior, for example, some vehicle emergency events that may occur on a road. Therefore, in an embodiment, risk analysis may be performed for an emergency event, to obtain, through filtering, a vehicle that is affected by the emergency event in order to provide a risk prompt to a plurality of vehicles, and better implement driving assistance. The following describes such a process of analyzing a driving risk and sending risk data, with reference to FIG. 15 and FIG. 16.

1001. A first device sends traffic environment data to a TCU.

When the first device is a vehicular device such as an OBU, if a vehicle is braked in an emergency, is abnormal, is out of control, or the like, the first device sends the traffic environment data (which may also be referred to as event data or alarm data) to the TCU such that the TCU can obtain an affected area through analysis, and send the traffic environment data to another first device in the affected area. The first device may send the traffic environment data to the TCU periodically (for example, at a frequency of 5 Hz) through a cellular network (an eNodeB). In other words, the traffic environment data is sent once whenever a preset period is reached. Event content in the traffic environment data sent each time may be the same, whereas location-related data and a timestamp that are included in the traffic environment data sent each time are different, to identify a current location and sending time. Such periodic sending can ensure effective delivery of the traffic environment data and can reflect a vehicle location change.

Certainly, a quantity of times of sending may be further limited during sending. In other words, when a quantity of times of sending the traffic environment data reaches a preset quantity, sending may be stopped, to avoid excessive occupation of transmission resources while a purpose of event notification is achieved.

1002. When the TCU receives the traffic environment data of the first device, the TCU extracts a location of the first device from the traffic environment data, and uses the location as a target location.

Step 1002 is a process of obtaining the target location, and the target location is a location at which the traffic environment data on which risk analysis is to be performed is generated. Because a traffic environment at the target location has changed, a second risk area needs to be determined based on the target location.

1003. The TCU determines a vehicle traveling line corresponding to the first device at the target location, where the vehicle traveling line corresponding to the first device includes at least one of a vehicle traveling line on which the first device is located, a vehicle traveling line adjacent to the first device, and a cross traveling line of the first device.

A process of determining the vehicle traveling line is similar to that in step 303. Details are not described herein again.

1004. The TCU classifies, as the second risk area, an area that is along the vehicle traveling line corresponding to the first device and that is in a fourth preset range ahead of and/or behind the first device.

When an emergency event occurs on the first device, an area affected by the emergency event is limited. Therefore, the area affected by the emergency event may be determined based on a location at which the emergency event occurs, namely, the location of the first device, to perform a subsequent data sending process based on the affected area obtained through classification.

It should be noted that a classification policy of the second risk area varies with an event type and/or a road segment configuration indicated by the traffic environment data. The road segment configuration may mean that different classification policies may be configured for different road segments. For example, when the event type indicated by the traffic environment data is an emergency braking alarm, during classification of the second risk area, only an area that is within 300 meters behind the first device and that is along the vehicle traveling line corresponding to the first device may be classified as the second risk area. For another example, when the event type indicated by the traffic environment data is an emergency rescue vehicle alarm, during classification of the second risk area, areas that are within 500 meters ahead of the first device and that are along the vehicle traveling line corresponding to the first device and the vehicle traveling line adjacent to the first device may be classified as second risk areas. Certainly, the foregoing descriptions are merely examples of classification manners. For specific classification, there may be different variations depending on features of different event types. This is not specifically limited in this embodiment of this application.

1005. The TCU filters vehicle status data in a vehicle status database based on the second risk area, to obtain at least one first device located in the second risk area.

The vehicle status data in the vehicle status database includes a location of each first device. Therefore, which first device is currently located in the second risk area affected by the traffic environment data can be learned of, to determine an affected first device. In addition, during subsequent sending, a sending sequence may be further determined based on a location of the at least one first device. Certainly, a filtering result may be that no device is obtained. In this case, the traffic environment data may be ignored, to save bandwidth resources.

1006. When the at least one first device includes two or more first devices, send the traffic environment data separately to the two or more first devices in ascending order of distances between the at least one first device and the target location.

The location of each first device is obtained, and a shorter distance between an affected device and the first device indicates greater impact of the traffic environment data on the device. Therefore, to ensure a timeliness requirement of event notification, a distance between each first device and an event occurrence location, namely, the target location, may be determined based on the location of the at least one first device, and then the traffic environment data is sent in ascending order of distances. Certainly, during data sending, the distances may not be considered. Instead, the data is sent to the at least one first device simultaneously, to achieve an effect of comprehensive notification.

1007. When any one of the at least one first device receives the traffic environment data, the any one first device provides a driving assistance prompt based on the event data.

It should be noted that data may be exchanged between the first device and the TCU based on a base station (such as an eNodeB) in a cellular network. In other words, step 1001 is actually a process in which the first device sends the traffic environment data to the TCU through an interface between the first device and the base station. After receiving the traffic environment data, the base station forwards the traffic environment data to the TCU based on a destination address of the traffic environment data using an LBO capability of the base station. Correspondingly, the data sending process in step 1007 may also be a process in which the TCU obtains cached address information of the first device and a cached address of the base station to which the first device belongs, and forwards the traffic environment data to the first device using the LBO capability of the base station. Certainly, the data exchange process is described using only an example in which the process is performed through LBO of the base station. In an embodiment, the data exchange process may be alternatively implemented using an LBO capability or an MEC capability of another network element device. The network element device is a radio base station, a wireless core-network network element, or a network element between a radio base station and a wireless core-network network element, such as an RGW or an EPC. The foregoing manner of performing communication using the LBO capability or the MEC capability can greatly reduce a communication latency.

According to the method provided in this embodiment of this application, when a risk analysis device receives the traffic environment data, the risk analysis device can classify an event-affected area in real time based on the location of the first device at which the traffic environment data is generated, and then reduce, based on the event-affected area, a range of devices to which the data is to be sent. Such small-range data sending greatly reduces a data sending latency while ensuring event notification, can reduce a bandwidth requirement for data sending and data receiving and reduce a frequency requirement for scheduling air interface resources, and improves communication performance. Further, distance-based sending can improve timeliness of the traffic environment data.

The foregoing embodiment is described using only an example in which a device that generates traffic environment data is a first device. In an embodiment, traffic environment data may be alternatively generated by a roadside device or a CSU. The following describes a sending process of such data with reference to FIG. 17 and FIG. 18.

1201. A second device sends traffic environment data to a TCU.

When the second device is a roadside device (a signal light or a signpost) or a CSU, if a status change, an event, or the like occurs on the device, the device sends the traffic environment data, for example, device status change data, to the TCU such that the TCU can obtain an affected area through analysis, and send the traffic environment data to another first device in the affected area. The first device may send alarm data to the TCU periodically (for example, at a frequency of 5 Hz) through a cellular network (an eNodeB). In other words, the traffic environment data is sent once whenever a preset period is reached. Event content in the traffic environment data sent each time may be the same, whereas location-related data and a timestamp that are included in the traffic environment data sent each time are different, to identify a current location and sending time. Such periodic sending can ensure effective delivery of the traffic environment data and can reflect a vehicle location change.

Certainly, a quantity of times of sending may be further limited during sending. In other words, when a quantity of times of sending the traffic environment data reaches a preset quantity, sending may be stopped, to avoid excessive occupation of transmission resources while a purpose of event notification is achieved.

It should be noted that data may be exchanged between the second device and the TCU based on a base station (such as an eNodeB) in a cellular network. In other words, step 1201 is actually a process in which the second device sends the traffic environment data to the TCU through an interface between the second device and the base station. After receiving the traffic environment data, the base station forwards the traffic environment data to the TCU based on a destination address of the traffic environment data using an LBO capability of the base station.

1202. When the TCU receives the traffic environment data of the second device, the TCU extracts a location of the second device from the traffic environment data, and uses the location as a target location.

Step 1202 is a process of obtaining the target location, and the target location is a location at which the traffic environment data is generated. Because a traffic environment at the target location has changed, a second risk area needs to be determined based on the target location.

Certainly, the second device in the embodiment shown in FIG. 17 may be a device with a fixed location. Therefore, a geographic information database may be further used to store the second device and the location of the second device. In this case, when the traffic environment data is received, the location may not be extracted based on the traffic environment data. Instead, a device identifier of the second device that generates the environment data is extracted from the traffic environment data, the location of the second device is obtained from the geographic information database based on the device identifier, and the location of the second device is used as the target location.

1203. The TCU obtains a vehicle traveling line in a control area of the second device at the target location.

Any second device with a fixed location, such as a signal light, a signpost, or a CSU, may correspond to a control area in a fixed range. For example, a control area of a signal light may be 500 meters behind the signal light on a traveling line indicated by the signal light. The control area and the vehicle traveling line in the control area may also be stored in the geographic information database such that such information can be used through database querying during risk analysis.

1204. The TCU classifies, as the second risk area, an area that is along the vehicle traveling line in the control area of the second device and that is in a fifth preset range in which the target location is traveled to.

An area affected when a status of the second device changes or the second device sends the traffic environment data is limited. Therefore, the affected area may be determined based on the location of the second device, to perform a subsequent data sending process based on the affected area obtained through classification.

It should be noted that a classification policy of the second risk area varies with an event type and/or a road segment configuration indicated by the traffic environment data. For example, when the event type indicated by the traffic environment data is a change of a signal light, during classification of the second risk area, only an area that is within 300 meters behind the first device and that is along a vehicle traveling line corresponding to the second device may be classified as the second risk area. For another example, when the event type indicated by the traffic environment data is a congestion alarm, during classification of the second risk area, areas that are within 500 meters behind the event location and that are along a vehicle traveling line corresponding to the first device and a vehicle traveling line adjacent to the first device may be classified as second risk areas. Certainly, the foregoing descriptions are merely examples of classification manners. For specific classification, there may be different variations depending on features of different event types. This is not specifically limited in this embodiment of this application.

1205. The TCU filters vehicle status data in a vehicle status database based on the second risk area, to obtain at least one first device located in the second risk area.

1206. When the at least one first device includes two or more first devices, send the traffic environment data separately to the two or more first devices in ascending order of distances between the at least one first device and the target location.

1207. When any one of the at least one first device receives the traffic environment data, the any one first device provides a driving assistance prompt based on the traffic environment data.

The first device may provide corresponding driving assistance prompts based on different types of traffic environment data. For example, when the traffic environment data is a congestion alarm, the first device may instruct a driver to change a lane.

Steps 1205 to 1207 are similar to steps 1005 to 1007. Details are not described herein again.

According to the method provided in this embodiment of this application, when a risk analysis device receives the traffic environment data, the risk analysis device can classify an event-affected area in real time based on the location of the second device at which the traffic environment data is generated, and then reduce, based on the event-affected area, a range of devices to which the data is to be sent. Such small-range data sending greatly reduces a data sending latency while ensuring event notification, can reduce a bandwidth requirement for data sending and data receiving and reduce a frequency requirement for scheduling air interface resources, and improves communication performance. Further, distance-based sending can improve timeliness of the traffic environment data.

It should be noted that in the embodiments shown in FIG. 15 and FIG. 17, descriptions are provided based on sending of the traffic environment data only. In an embodiment, traffic environment data may be sent together with vehicle status data and sensed data. In other words, when a risk analysis period of the first device is reached, the traffic environment data is added to risk data, and the risk data is sent to the first device such that the first device in the affected area can receive more comprehensive risk data using limited transmission resources.

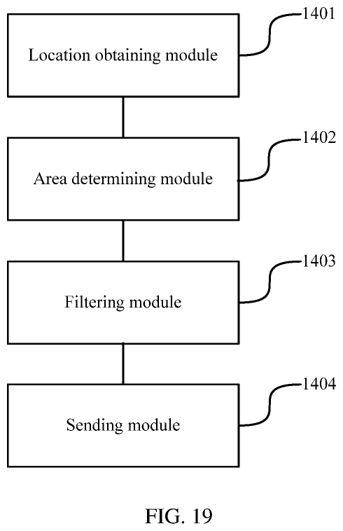

FIG. 19 is a schematic structural diagram of an apparatus for analyzing a driving risk and sending risk data according to an embodiment of this application. The apparatus may be applied to a risk analysis device, and the apparatus includes a location obtaining module 1401 configured to obtain a location of a first device on which risk analysis is to be performed, an area determining module 1402 configured to determine a first risk area based on a vehicle traveling line corresponding to the location, where the first risk area is an area that affects a driving behavior of a vehicle in which the first device is located, a filtering module 1403 configured to perform filtering for the first risk area, to obtain risk data, and a sending module 1404 configured to send the risk data to the first device, where the risk data includes status data of a vehicle, a pedestrian, and an obstacle that have a risk of colliding with the vehicle in which the first device is located, and traffic environment data that affects the driving behavior of the vehicle in which the first device is located.

In a possible design, the location obtaining module 1401 is configured to perform steps 301 and 302, or is configured to perform steps 601 and 602, or is configured to perform steps 801 and 802.

In a possible design, the area determining module 1402 is configured to perform steps 303 and 304, or is configured to perform steps 603 and 604, or is configured to perform steps 803 and 804.

In a possible design, the filtering module 1403 is configured to perform step 305, step 605, or step 805.

In a possible design, the risk data is current-moment risk data obtained through prediction.

In a possible design, the filtering module 1403 is further configured to perform step 806.

In a possible design, the sending module 1404 is configured to perform step 306, step 606, or step 807.

In a possible design, sending policies corresponding to different emergency degrees are preconfigured by the risk analysis device or determined based on a request of the first device.

In a possible design, data is exchanged between the first device and the risk analysis device based on an LBO function or an MEC function of a network element device in a cellular network, and the network element device is a radio base station, a wireless core-network network element, or a network element between a radio base station and a wireless core-network network element.

In a possible design, the sending module is configured to obtain stored address information of the first device and stored address information of a network element device to which the first device belongs and that directly interacts with the risk analysis device, and send the risk data using the network element device to which the first device belongs.

In a possible design, the first device includes any terminal device that supports V2X.

In a possible design, the terminal device that supports V2X includes an OBU, a smartphone, an T-Box, or an event data recorder.

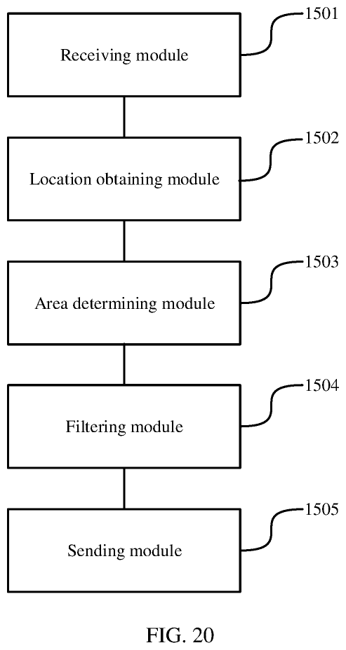

FIG. 20 is a schematic structural diagram of an apparatus for analyzing a driving risk and sending risk data according to an embodiment of this application. The apparatus may be applied to a risk analysis device, and the apparatus includes a receiving module 1501 configured to receive traffic environment data, a location obtaining module 1502 configured to obtain a target location, where the target location is a location at which the traffic environment data on which risk analysis is to be performed is generated, an area determining module 1503 configured to determine a second risk area based on a vehicle traveling line corresponding to the target location, where the second risk area is an area that is affected by a status change of a second device at the target location, a filtering module 1504 configured to perform filtering for a first device in the second risk area, and a sending module 1505 configured to send the traffic environment data to at least one first device that is obtained through filtering.

In a possible design, the sending module 1505 is further configured to ignore the traffic environment data when no device is obtained through filtering.

In a possible design, the location obtaining module 1502 is configured to perform step 1002 or step 1202.

In a possible design, the area determining module 1503 is configured to perform step 1003 and step 1004, or step 1203 and step 1204.

In a possible design, the second device is a traffic signal light, a signpost, or a CSU.

In a possible design, a classification policy of the second risk area varies with an event type and/or a road segment configuration indicated by the traffic environment data.

In a possible design, the filtering module is configured to perform step 1005 or step 1205.

In a possible design, the sending module is configured to, when a risk analysis period of any one of the at least one first device is reached, add the traffic environment data to risk data, and send the risk data to the first device.

A person of ordinary skill in the art may understand that all or some of the steps of the embodiments may be implemented by hardware or a program instructing related hardware. The program may be stored in a computer readable storage medium. The storage medium may be a read-only memory, a magnetic disk, a compact disc, or the like.

The foregoing descriptions are merely optional embodiments of this application, but are not intended to limit this application. Any modification, equivalent replacement, improvement, or the like made without departing from the spirit and principle of this application shall fall within the protection scope of this application.

What is claimed is:

1. A method for analyzing implemented by a risk analysis device, wherein the method comprises:
obtaining a location of a first device on which a risk analysis is to be performed;
determining a first risk area based on a vehicle traveling line corresponding to the location, wherein the first risk area affects a driving behavior of a vehicle in which the first device is located;
filtering the first risk area to obtain risk data; and
sending the risk data to the first device, wherein the risk data comprises status data and traffic environment data, wherein the status data describes an obstacle that has a risk of colliding with the vehicle in which the first device is located, and wherein the traffic environment data describes an environment that affects the driving behavior of the vehicle in which the first device is located.

2. The method of claim 1, further comprising:
receiving vehicle status data of the first device and extracting the location of the first device from the vehicle status data; or
extracting the location of the first device from a vehicle status database when a risk analysis period of the first device is reached, wherein the vehicle status database stores status data of all first devices in a control area of the risk analysis device.

3. The method of claim 1, wherein determining the first risk area based on the vehicle traveling line corresponding to the location comprises:
determining a vehicle traveling line corresponding to the first device based on the location, wherein the vehicle traveling line corresponding to the first device comprises at least one of a vehicle traveling line on which the first device is located, a vehicle traveling line adjacent to the vehicle traveling line on which the first device is located, or a traveling line that crosses the vehicle traveling line on which the first device is located; and
classifying at least one of a first subarea, a second subarea, or a third subarea as the first risk area, wherein the first subarea is in a first preset range ahead of or behind the first device and is located on the vehicle traveling line on which the first device is located, wherein the second subarea is in a second preset range ahead of or behind the first device and is located on the vehicle traveling line adjacent to the vehicle traveling line on which the first device is located, and wherein the third subarea is in a third preset range in which a cross point is traveled to and is located on the traveling line that crosses the vehicle traveling line on which the first device is located.

4. The method of claim 1, further comprising:
filtering vehicle status data in a vehicle status database based on the first risk area or filtering sensed data in a database of sensor data based on the first risk area; and
obtaining the vehicle status data or the sensed data of a second vehicle in the first risk area, wherein the vehicle status data is as the risk data.

5. The method of claim 1, wherein performing filtering for the first risk area to obtain the risk data comprises:
filtering traffic environment data in a traffic environment database based on the first risk area; and
obtaining the traffic environment data of a second vehicle in the first risk area, wherein the traffic environment data is as the risk data.

6. The method of claim 1, further comprising:
sending the risk data whose emergency degree is higher than or equal to a preset high level to the first device when a first period is reached, sending the risk data whose emergency degree is higher than or equal to a preset medium level to the first device when a second period is reached, and sending the risk data to the first device when a third period is reached, wherein a time span of the first period is less than a time span of the second period, and wherein the time span of the second period is less than a time span of the third period;
sending the risk data whose emergency degree is higher than or equal to the preset high level to the first device when the first period is reached, and sending the risk data to the first device when the second period or the third period is reached; or
sending the risk data to the first device when a risk analysis period of the first device is reached.

7. The method of claim 6, further comprising:
preconfiguring sending policies corresponding to different emergency degrees; or
determining the sending policies based on a request from the first device.

8. The method of claim 1, further comprising:
packetizing the risk data into a data packet and sending the data packet to the first device when the risk data comprises status data of two or more devices; or
packetizing each piece of status data into the data packet to obtain a plurality of data packets and sending the data packets sequentially to the first device when the risk data comprises the status data of the two or more devices.

9. The method of claim 8, further comprising sending the data packets to the first device in descending order of emergency degrees of the status data.

10. The method of claim 1, further comprising exchanging data with the first device based on a local breakout (LBO) function or a mobile edge computing (MEC) function of a network element device in a cellular network, wherein the network element device is a radio base station, a wireless core-network network element, or a network element between the radio base station and the wireless core-network network element.

11. The method of claim 10, further comprising:
obtaining stored address information of the first device;
obtaining stored address information of the network element device to which the first device belongs and that directly interacts with the risk analysis device; and
sending the risk data using the network element device to which the first device belongs.

12. The method of claim 1, wherein the first device comprises a terminal device that supports vehicle to everything (V2X).

13. The method of claim 12, wherein the terminal device comprises an on-board unit (OBU), a smartphone, an on-board control unit (T-Box), or an event data recorder.

14. A method implemented by a risk analysis device, wherein the method comprises:
receiving traffic environment data;
obtaining a target location, wherein the target location is where the traffic environment data on which risk analysis is to be performed;
determining a second risk area based on a vehicle traveling line corresponding to the target location, wherein the second risk area is affected by a status change of a second device at the target location;
filtering for a first device in the second risk area; and
sending the traffic environment data to the first device when filtering is successful.

15. The method of claim 14, further comprising skipping sending the traffic environment data when filtering is unsuccessful.

16. The method of claim 14, further comprising:
extracting the target location from the traffic environment data; or
extracting a device identifier of the second device from the traffic environment data, obtaining a location of the second device from a geographic information database based on the device identifier, and using the location of the second device as the target location.

17. The method of claim 14, further comprising:
determining a vehicle traveling line corresponding to the first device at the target location when the second device is the first device, wherein the vehicle traveling line corresponding to the first device comprises at least one of a vehicle traveling line on which the first device is located, a vehicle traveling line adjacent to the vehicle traveling line on which the first device is located, or a traveling line that crosses the vehicle traveling line on which the first device is located; and
classifying, as the second risk area, an area that is along the vehicle traveling line corresponding to the first device and that is in a fourth preset range ahead of or behind the first device.

18. The method of claim 14, further comprising:
obtaining a vehicle traveling line in a control area of the second device at the target location based on the control area of the second device at the target location; and
classifying an area that is along the vehicle traveling line and that is in a fifth preset range in which the target location is traveling as the second risk area.

19. The method of claim 18, wherein the second device is a traffic signal light, a signpost, or a central service unit (CSU).

20. The method of claim 17, wherein a classification policy of the second risk area varies with an event type or a road segment configuration indicated by the traffic environment data.

21. The method of claim 14, further comprises further filtering vehicle status data in a vehicle status database to obtain the first device located in the second risk area based on the second risk area.

22. The method of claim 14, further comprising sending the traffic environment data separately to two or more first devices in ascending order of distances between the first device and the target location when the first device comprises the two or more first devices.

23. The method of claim 14, further comprising:
adding the traffic environment data to the risk data; and
sending the risk data to the first device when a risk analysis period of any one of the first device is reached.

24. An apparatus for analyzing driving risk and sending risk data, comprising:
a processor; and
a memory coupled to the processor and storing instructions that, when executed by the processor, cause the apparatus to be configured to:
obtain a location of a first device on which risk analysis is to be performed;
determine a first risk area based on a vehicle traveling line corresponding to the location, wherein the first risk area affects a driving behavior of a vehicle in which the first device is located;
filter the first risk area to obtain the risk data; and
send the risk data to the first device, wherein the risk data comprises status data and traffic environment data, wherein the status data describes an obstacle that has a risk of colliding with the vehicle in which the first device is located, wherein the traffic environment data describes an environment that affects the driving behavior of the vehicle in which the first device is located.

25. An apparatus for analyzing driving risk and sending risk data, comprising:
a processor; and
a memory coupled to the processor and storing instructions that, when executed by the processor, cause the apparatus to be configured to:
receive traffic environment data;
obtain a target location, wherein the target location is where the traffic environment data on which risk analysis is to be performed;
determine a second risk area based on a vehicle traveling line corresponding to the target location, wherein the second risk area is an area that is affected by a status change of a second device at the target location;
filter for a first device in the second risk area; and
send the traffic environment data to the first device.
